(19) United States
(12) Patent Application Publication
(10) Pub. No.: US 2013/0024359 A1
(43) Pub. Date: Jan. 24, 2013

(54) Peer-to-Peer Lending Method and System

(71) Applicant: Martin John Wright, London (GB)

(72) Inventor: Martin John Wright, London (GB)

(21) Appl. No.: 13/549,260

(22) Filed: Jul. 13, 2012

(30) Foreign Application Priority Data
Jul. 20, 2011 (GB) GB1112449.2

(51) Int. Cl. G06Q 40/02

(52) U.S. Cl. 705/38

(57) ABSTRACT

A dental floss apparatus comprised of a pair of handles that are configured for engagement with the fingers with strands of flossing substrate extending therebetween. The flossing substrates are spaced from each other, running substantially parallel and extending within an opening formed between the ends of the handles. A dissolvable substrate is positioned within this opening through an engagement with one or both of the handles or the flossing substrate, and upon contact with the surface of the teeth, dissolves, and deposits a residue on the surface of the teeth and the surrounding area of the mouth. The dissolvable substrate may be formed of two substrate pieces with a central gap between them defining a means for targeting insertion of the substrate between adjacent teeth and may be colorized or luminescent and have an additive material such as mouthwash, breath freshener, cooling agent, or flavor.

### FIELD OF THE INVENTION

This application claims priority to UK application number GB1112442.9 filed on Jul. 20, 2011. The present invention relates to peer-to-peer lending between lenders and borrowers where individuals act as lenders selectably, dependently upon intelligence concerning the borrowers, to lend sums of money to other individuals who are the borrowers.

It is to be understood that the term “individual” refers herein to any legal person, and includes in its meanings individual persons and companies and corporations.

### THE PRIOR ART

Different forms of peer to peer lending are already known, and are used, for example, in the activity of micro funding or micro-finance, where small amounts are made available to individuals in impoverished circumstances to assist them in overcoming their circumstances. The root activity of peer to peer lending and associated activities are disclosed in the following United States patent documents:

US Patent Application US 2008052224 discloses guaranteed peer-to-peer lending in which loan payments between a borrower and a lender include an allocation to an account of a guarantor includes in one aspect a selection of borrower classes including a guaranteed class made available by a server to a first client machine. The server receives from lenders at respective first clients machines respective lender-parameters and respective selected borrower-classes. In the event that the selected borrower-class is the guaranteed class, the allocation of a portion of any loan payments to the collateral account of the guarantor is made automatically. In another aspect, offers are transmitted to lenders concerning a guarantee of any loan that satisfies the lender's parameters in exchange for a guarantor premium, which premium comprises a portion of any loan payments otherwise due to or collected by the lender for credit in to a collateral account of a guarantor. The present invention seeks to provide improvement there-over by allowing greater freedom in offers.

United States Patent Application US 2008294546 discloses a system and method for an online, peer-to-peer lending platform for micro-finance. Individual and personal lenders across the world can uniquely loan to specific micro-enterprises in many countries and geographic areas in a highly personal and effective manner. The system and method functions as a bridge between individual lender and borrower by providing elements and steps for facilitating and processing micro-finance institution (MFI) transactions. The transaction includes providing the borrower's location, the type of business the borrower will engage in, borrower reputation information, and information on the micro-financial institution that would distribute the loan funds to the borrower. An interface selects the borrower and identifies an amount of money to be lent to the borrower. The present invention seeks to provide improvement there-over by providing for greater confidence and surety on the borrowing and lending process.

U.S. Pat. No. 7,873,569 discloses a web-based loan auction system that is available to individual borrowers and individual lenders and is well suited for individual borrowers that cannot meet the standards of conventional lending institutions. The system is also attractive to potential lenders that desire to achieve a higher return on their investment than currently offered by banks. The potential borrower submits a web-based loan application to the auction system. Once the loan application information is verified (a function performed by the agency offering the auction service), the application is translated into an “anonymous” version, where the personal information of the borrower himself is replaced by “placeholders” known and controlled by the auction service. The “anonymized” version of the loan application is then posted on the auction's web site for bidding by potential lenders. The present invention seeks to provide improvement there-over by providing to lenders greater security in their loan.

The advantages and improvements afforded by the invention will become better understood by the following description and summary.

### SUMMARY OF THE INVENTION

According to a first aspect, the present invention provides a method for auctioning provision of a loan automatically employing an auction server the method comprising: a step of the auction server automatically providing an auction server website; a step of the auction server automatically interacting with a borrowing client to post a borrowing request on the auction server website on behalf of the borrowing client; a step of the auction server automatically interacting with at least one lending client to receive a bid to win a first auction to provide the requested loan amount; a step of the auction server automatically interacting with at least one default guarantor client to receive a bid to win a second auction to provide a default guarantee for the requested loan amount; a step of the auction server automatically terminating the auction process when one or more predetermined criteria are met; and a step of the auction server automatically selecting the lowest cost bidder for the first auction and the lowest cost bidder for the second auction for presentation to the borrowing client for acceptance of the loan offer.

According to a second aspect, the present invention provides a system for auctioning provision of a loan; the system comprising: an auction server; the auction server comprising website provision means operable to provide an auction server website; the auction server comprising borrowing client interaction means operable to interact with a borrowing client and to post a borrowing request on the auction server website on behalf of the borrowing client; the auction server comprising lending client interaction means operable to interact with at least one lending client to receive a bid to win a first auction to provide the requested loan amount; the auction server comprising default guarantor interaction means operable to interact with at least one default guarantor client to receive a bid to win a second auction to provide a default guarantee for the requested loan amount; the auction server comprising termination means, operable to terminate the auction process when one or more predetermined criteria are met; and the auction server comprising bidder selection means operable automatically to select the lowest cost bidder for the first auction and the lowest cost bidder for the second auction and further operable to present the selected bids to the borrowing client for acceptance of the loan offer.

The present invention also provides that the one or more criteria can include at least one of: the end of a predetermined period of elapsed time; the overall load cost falling below a preset value selected by the borrowing client; the interest rate set by a lending client falling below a preset value selected by the borrowing client; the interest rate set by a default guarantor client falling below a preset value selected by the borrowing client.

The present invention also provides that, if the borrowing client accepts the loan offer, the auction server and automatically provides an escrow account for deposition of the loan amount by the lending client and for making available the loan amount to the borrowing client.

The present invention also provides that the auction server can automatically allow deposition of monies by the borrowing client when payments are due; and can allow transfer of monies to at least one of: the lending client; and the default guarantor client.

The present invention also provides that the auction server can automatically interact with at least one exchange rate guarantor client to receive a bid to win a third auction to provide an exchange rate guarantee for the requested loan; where the auction server can automatically select the lowest cost bidder for the third auction for presentation to the borrowing client for acceptance.

### BRIEF DESCRIPTION OF THE DRAWINGS

The invention is further described and explained, by way of example, by the following description to be read in conjunction with the appended drawings, in which:

FIG. 1 is a schematic diagram illustrating an exemplary environment for the invention.

FIG. 2 is an exemplary flow chart illustrating one way in which the auction server of FIG. 1 can accept access from the many different types of clients.

FIG. 3 is a flow chart showing one possible example of the activities of the auction server when a borrower client is the accessing client.

FIG. 4 is an exemplary flow chart illustrating one manner in which the auction server can respond to access from a lender client, a default guarantor client or an exchange rate guarantor client. and

FIG. 5 is an exemplary flow chart illustrating one manner in which the auction server 10 can handle the overall auction process.

### DETAILED DESCRIPTION OF THE INVENTION

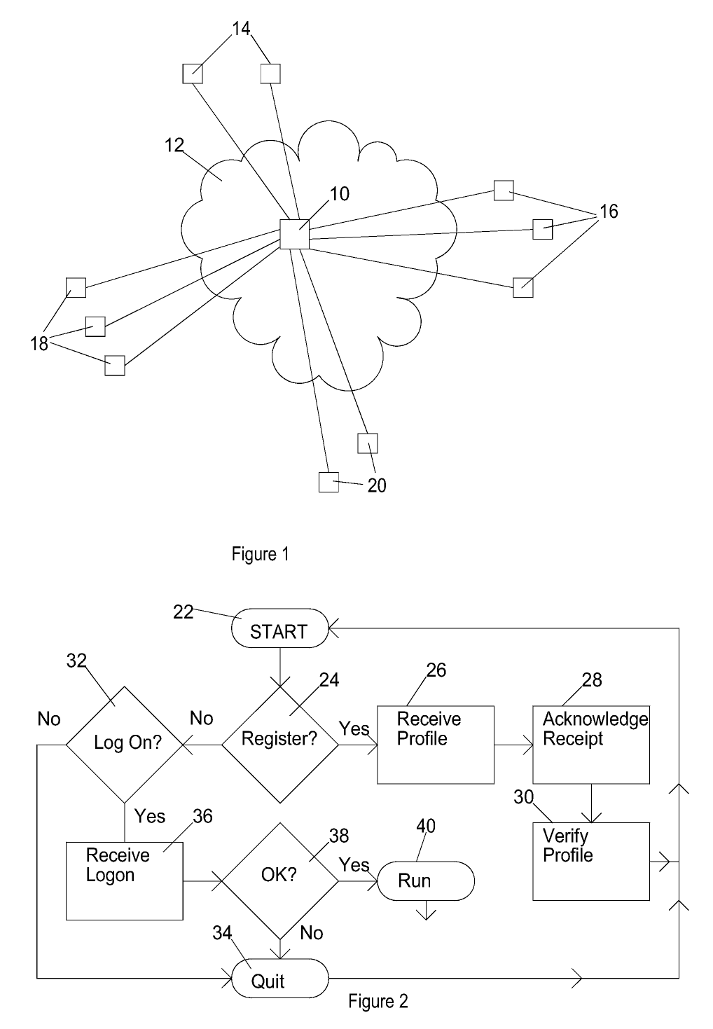

Attention is first drawn to FIG. 1, a schematic diagram illustrating an exemplary environment for the invention.

An auction website employs an auction server 10 provided within a network 12 such as, but not limited to; the internet; a local area network (LAN); and a wide area network (WAN).

The auction server 10 can be a single server providing all functions, or may be constituted as a so-called “cloud” where single network address access is provided to the combined services of a plurality of servers in co-operation with one another.

The auction website operates as a peer to peer (also known as a person to person) lending website. The auction server 10 is operable to provide two-way communications with a plurality of client machines 14 16 18 20 operated by different classes of individuals or organizations within the ambit of per to peer lending.

The client machines 14 16 18 20 can be any device with network 12 access enabled and includes, but is not limited to; portable personal computers (PC); desktop personal computers; portable tablet computers; and mobile telephone devices.

A first kind of client machine 14 is operated by one or more borrowers, being a first class of individual. Hereafter, the distinction between the class of individual and the client machine that they operate is blurred, so that when reference is made, for example, to a “borrower”, it is to be understood that it can also mean signals and data provided to and from a borrower client machine 14 and the individual 14 is also allotted the number of the client machine 14. Similarly, the distinction between the auction website and the auction server 10 is also hereafter blurred, so the references to the auction website 10 also means the auction server 10 and what information the auction server 1 make and what decisions the auction server 10 makes operating under its computer program control.

A borrower 14 wishes to obtain a loan from as yet unknown individual. To obtain the loan, the borrower 14, just as any auction site, submits a confirmed request to the auction website 10 and, in return, the auction website 10 sets up a page for display of the borrowing request and also receives and assesses any responses received in response to the request page. The request “page” can be one or more pages.

A second class of individuals comprises one or more “lenders” 16 operating one or more lender client machines 16. A lender 16 offers, as a lender bid, to fill the loan request from the borrower 14 at a rate of interest set down by the particular lender. The different lender bids are gathered by the auction website 10 and, at the end of the auction period, the lender bid with the lowest interest rate is selected by the auction website as the winning bid.

A further set of individuals comprises one or more default guarantors 18 who either are automatically notified of the borrowing request or who find the request by searching among the pages made available by the auction web site 10. A default guarantor 18, if a lender 16 indicates a desire to have an exchange rate guarantor 18, or if the lender 16 fails to make such an indication, bids a percentage of the loan amount as the price for repaying the residual amount of the loan to the lender 16 in the event of the borrower 14 defaulting.

Yet a further set of individuals comprises one or more exchange rate guarantors 20 who are also either automatically notified of the borrowing request or who find the request by searching among the pages made available by the auction web site 10. An exchange rate guarantor 20, if a lender 16 indicates a desire to have an exchange rate guarantor 18, or if the lender 16 fails to make such an indication, bids a percentage of the loan amount as the price for repaying the difference of the loan and its repayments to the lender 16 in the event of the exchange rate moving to alter the repayment amounts paid to the lender 16.

It is an alternative option, within the invention, that a default guarantor 16 and an exchange rate guarantor 20 can bid whether or not a lender has indicated a desire for guarantor 18 20 involvement in the lender's 16 bid.

It is to be appreciated that bids, whether they be made by a lender 16, a default guarantor 18 of an exchange rate guarantor 20, can be for the whole of the amount of the borrowing request, or only for part of it. The amount of any borrowing request can be made up by plural combined lenders 16, default guarantors 18 and exchange rate guarantors 20.

If the exchange rate moves in the exchange rate guarantor's 20 favour, then the exchange rate guarantor 20 gets to keep that profit in addition to the premium that the exchange rate guarantor 20 receives. That is, the exchange rate guarantor 20 guarantees a given exchange rate between 2 currencies, rather than guaranteeing a minimum exchange rate in the lender's favour.

In the case of exchange rate guarantors, it is an option that the auction server 10 can limit which currencies are allowed; As an example, if the loan is denominated in British Pounds (£) then the system can allow a guarantor to guarantee the British Pounds to US Dollar ($) exchange rate, but might not allow an exchange rate guarantor 20 to guarantee the British Pounds to Brazilian Rais (R$) if regulations forbid it.

The request page can include one or more of: financial detail concerning the borrowing client 14 likely to provide an idea of risk attached to making the loan; and criteria for ending of the auction process. The criteria can include at least one of: the end of a predetermined period of elapsed time; the overall loan load cost falling below a preset value selected by the borrowing client 14; the interest rate set by a lending client 16 falling below a preset value selected by the borrowing client 14; the interest rate set by a default guarantor client 18 falling below a preset value selected by the borrowing client 14; and the interest rate set by an exchange rate guarantor client 20 falling below a preset value selected by the borrowing client 14.

Lending clients 16, default guarantor clients 18 and exchange rate guarantor clients 20 can use the borrowing clients financial details as a guide to the risk attached the loan or its guarantees, and can set their assessed costs, expressible as a percentage or an interest rate, in the bids they make. It is also expected and advisable that lending clients 16, default guarantor clients 18 and exchange rate guarantor clients 20 should make their own assessment and investigations into the borrowing client 14 and into the financial markets more accurately to assess risk attached to the loan.

Attention is next drawn to FIG. 2, an exemplary flow chart illustrating one way in which the auction server 10 can accept access from the many different types of clients 14 16 18 20.

From a start 22 where the auction server 10 presents a start-up screen to the accessing client 14 16 18 20 a first test 24 looks to see if the client might be a new client 14 16 18 20 and would therefore desire to register.

If the first test 24 finds that the accessing client 14 16 18 20 does desire to register, a first operation 26 accepts registration details from the registrant. The registration details can include, but are not limited to: registrant name; registrant address; registrant company; type of client namely borrower 14, lender 16, default guarantor 18, exchange rate guarantor; checkable details confirming the registrant's bona fides; a name to be used to identify the registrant in operation of the bid process of the auction server 10; a password to be used whenever the registrant should sign in to gain access the auction server 10 in future; and the registrant's email address.

Having automatically accepted the registrant details, a second operation 28 automatically acknowledges receipt of the details by, for example, but not limited to, by sending an email to the registrant's email address providing a URL (website address) that the registrant can access to verify that the registration attempt originated with the registrant and not with some other party.

A third operation 30 then has the auction server 10 automatically check and verify the registrant's checkable details given in the course of the first operation and also accesses other sites where financial data regarding the registrant may be available. These other sites can include, but are not limited to: one or more credit reference agencies; one or more bank reference sites; one or more registers where individual records are available; and one or more registers where company or corporations details are available. The third operation 30 then returns control to start 22.

If the first test does not detect that the accessing client 14 16 18 20 desires to register with the auction server 10, a second test 32 checks to see if the accessing client 14 16 18 120 desires to log on to the auction server 10 site. If the accessing client 14 16 18 20 does not desire to log on, the second test 32 passes control to an access exit 34 which terminates the access process and returns operation back to the start 22 to await further access attempts.

If the second test 32 finds that the accessing client 14 16 18 20 does wish to log on, a fourth operation 40 accepts the logon details and a third test 38 attempts to verify the logon details. The third test can offer the accessing client 14 16 18 20 one or more attempts to get the logon details acceptable.

If, after the one or more attempts to get the logon details acceptable, the third test 38 finds that the logon details are (still) not acceptable, control is passed to the access exit 34. If the third test 38 finds the logon details acceptable, control is passed to an operational exit 40 which permits the accessing client 14 16 18 20 access to the auction server 10 site to conduct their business.

FIG. 2 shows just one example possible activities of the auction server 10 site which can be used to allow access of servers 14 16 18 20 to the auction server 10 website. Those skilled in the art will be aware that other possibilities can be used without departing from the scope of the invention as claimed hereafter.

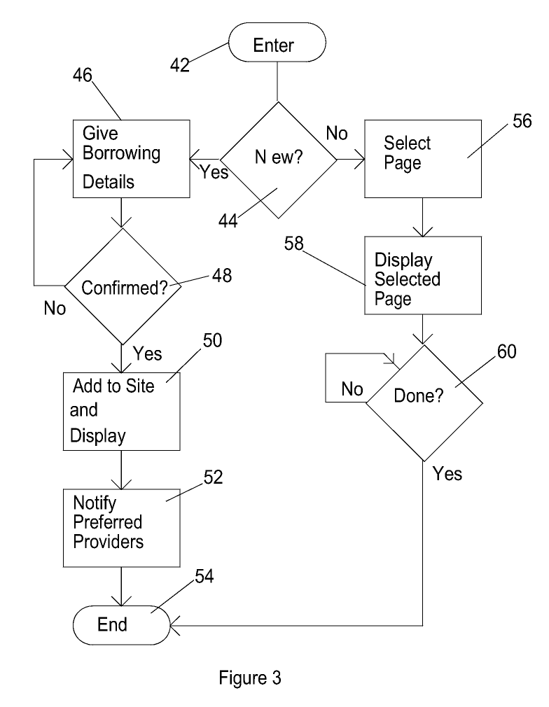

Attention is next drawn to FIG. 3, a flow chart showing one possible example of the activities of the auction server 10 when a borrower client 14 is the accessing client 14.

Entry 42 is successor in control from operational exit 40. Entry 42 passes control to a fourth test 44 which checks to see if the borrowing client 14 wishes to post a new borrowing request or if the borrowing client 14 wishes merely to view the progress of an existing borrowing request.

If the fourth test 44 finds that the borrowing client 14 wishes to post a new borrowing request, a fifth operation 46 prompts and gathers the details of the new borrowing request from the borrowing client 14.

The details of the borrowing request can include, but are not limited to: the amount of the loan; the period of the loan; how many parallel loans are included in the borrowing client's 14 portfolio; the expected interest rate; and the frequency of payments made e.g. monthly, quarterly, annually etc.

Once a fifth test 48 finds that the borrowing client 14 has confirmed the borrowing request details, a sixth operation 50 adds a generated page to the auction server 10 site and displays it for the borrowing clients 14 and any other clients 16 18 20 to see.

A seventh operation 52 then notifies preferred providers of loans and guarantees.

A preferred provided may be a lender client 16 who is selected by the managers of the auction server site 10 to be notified each time a new borrowing request is made. The preferred lending client 16 may also have been the result of payment, as a result of a separate transaction, to the organizers of the auction server 10 site to be notified of each time a new borrowing request is made.

A preferred client may be a default guarantor client 18. The preferred default guarantor clients 18 are automatically contacted. The selection of preferred default guarantor clients 18 by the auction server 10 site is made on the same basis as the auction server 10 site makes the selection of preferred lender clients 16.

A preferred client may be an exchange rate guarantor client 20. The preferred exchange rate guarantor clients 20 are automatically contacted. The selection of preferred exchange rate guarantor clients 20 by the auction server 10 site is made on the same basis as the auction server 10 site makes the selection of preferred lender client 16 clients and of preferred default guarantor clients 18.

The seventh operation 54 passes control to an operational end 54 where access by the borrowing to the auction server 10 site is terminated.

If the fourth test 44 finds that the borrowing client 14 does not wish to set up a new borrowing request, an eighth operation 56 selects the page of the auction server 10 site which the borrowing client 14 wishes to see. A ninth operation 58 then displays the selected page until a sixth test 60 finds that the inspecting borrowing client 14 is ended, when control is passed to the operational end 54.

It is to be appreciated that the description of FIG. 3 represents just one example of how the auction server 10 site can respond to borrowing client 14 access. Those skilled in the art will be aware of variations and other manners of access response that fall within the invention as hereafter claimed.

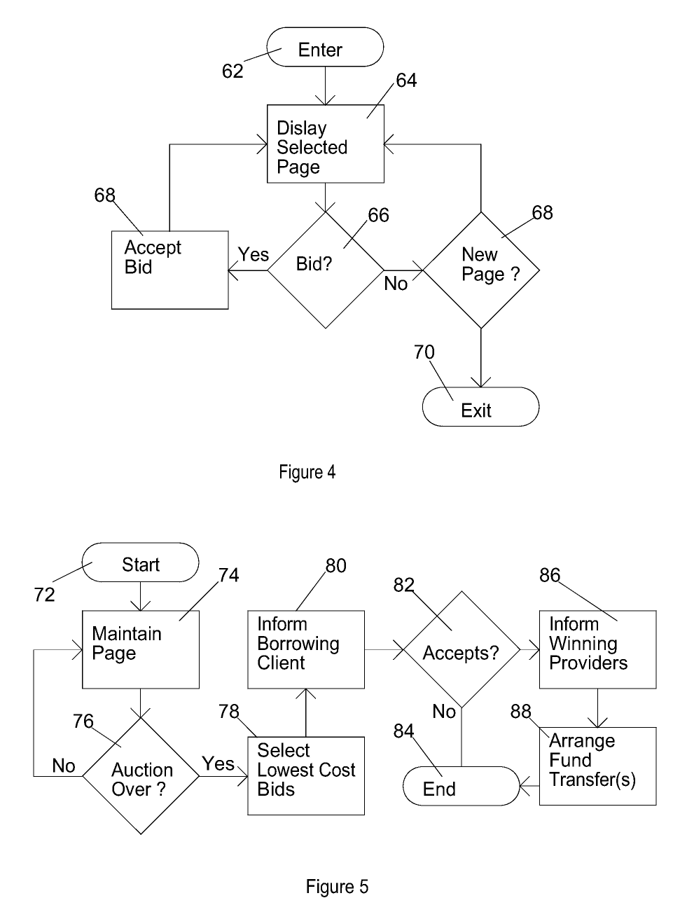

Attention is next drawn to FIG. 4, an exemplary flow chart illustrating one manner in which the auction server 10 site can respond to access from a lender client 16, a default guarantor client 18 or an exchange rate guarantor 20 client.

From entry 62 a tenth operation 64 displays the selected page of the borrowing request to the accessing clients 16 18 20. The accessing clients 16 18 20 may have been notified of the existence of the new borrowing request as a result of notification seventh test 66 as a result of the seventh operation 52. Alternatively, the accessing clients 16 18 20 may have found the page of the borrowing request by searching or browsing the plural borrowing request pages available in the auction server 10 site.

A seventh test 66 looks to see if the accessing client 16 18 20 wishes to bid on the borrowing request. A lender client 16 can always bid, but a default guarantor 18 and an exchange rate guarantor client 20 can only bid if the borrowing request indicates that they are welcome to join in as part of a bid.

If the seventh test 66 finds indication from the accessing client 16 18 20 that they desire to make a bid, an eleventh operation 68 accepts the bid conditionally upon its being allowed, and passed back control to the tenth operation 64 which displays the selected page with the new bid included.

If the seventh test 66 finds that the accessing client 16 18 20 does not wish to make a bid, an eighth test 70 looks to see if the accessing client 16 18 20 wishes to view another borrowing request page. If the accessing client 16 18 20 does not wish to view another borrowing request page, the seventh test passes control to exit 70 to terminate the access session of the accessing client 16 18 20. If the accessing client 16 18 20 does wish to view another borrowing request page, the seventh test passes control to the tenth operation 64 to display the next selected page.

The auction server 10 site, in accepting bidding access by the accessing clients 16 18 20, knows from the identity of each accessing client 16 18 20 whether a particular accessing client 16 18 20 is a lender client 14, a default guarantor client 16, or an exchange rate guarantor client 20, and automatically adds the bid to borrowing request page in the appropriate category.

By this process, an accessing client 16 18 20 can access plural borrowing request pages and place bids for selected borrowing requests.

Those skilled in the art will be aware that the description of FIG. 4 shows only one of many different possible manners in which the auction server 10 site can handle access by lender clients 16, default guarantor clients and exchange rate guarantor clients 20 and that many variations are possible within the scope of the invention as hereafter claimed.

The present invention transforms the process of bidding in an auction to fill a loan request posted by a borrowing client 14, in a first stage, by permitting participation by one or more default guarantor clients 18 who can provide bids for guaranteeing a lender client 16 against default by the borrower client 14 thereby providing a utility, sureness and certainty not previously available.

The present invention also transforms the process of bidding in an auction to fill a loan request posted by a borrowing client 14, in a second stage, by permitting participation by one or more exchange rate guarantor clients 20 who can provide bids for guaranteeing a lender client 16 against disadvantageous exchange rate fluctuations during the period of loan repayment thereby providing an even greater utility, sureness and certainty not previously available

Attention is next drawn to FIG. 5, an exemplary flow chart illustrating one manner in which the auction server 10 can handle the overall auction process.

From start 72 a twelfth operation 74 maintains the borrowing request page, adding and storing each new bid, until a ninth test 76 detects that the auction is over.

The end of the auction can be indicated by a number of criteria, including, but not limited to, one, all or some of: the end of a predetermined period of elapsed time; the overall load cost falling below a preset value selected by the borrowing client 14; the interest rate set by a lending client 16 falling below a preset value selected by the borrowing client 14; the interest rate set by a default guarantor client 18 falling below a preset value selected by the borrowing client 14; and the interest rate set by an exchange rate guarantor client 20 falling below a preset value selected by the borrowing client 14.

The present invention, yet further, transforms the process of bidding in an auction to fill a loan request posted by a borrowing client 14 by permitting one or more criteria to be used to end the overall auction process allowing a borrowing client 14 to obtain a loan within shorter time limits and according to other criteria that the borrowing client 14 may find essential or desirable.

If the auction is over, a thirteenth operation 78 selects the lowest bids and a fourteenth operation 80 has the auction server 10 Inform the borrowing client 14 that the auction has come to an end, informing the borrowing client 14 the overall cost of the loan and its components, and enquiring of the borrowing client 14 whether of not the borrowing client wishes to accept the loan. Filling the borrowing request may be a mixed combination of individual loans from lenders 16 and guarantors 18 20. The auction server 10 automatically selects the lowest cost agglomeration that can fill the borrowing request.

If a tenth test 82 finds that the borrowing client 14 does not wish to accept the proffered loan, control is passed to an exit 84 which terminates the auction process. As an alternative, the auction server 10 can progress, in order of increasing overall cost, through a sequence of loan options until the borrower 14 is offered an acceptable loan or indicates a wish to withdraw.

If the tenth test 82 finds that the borrowing client 14 does wish to accept the proffered loan options, control is passed to fifteenth operation 86 which has the action server 10 inform the winning providers that they have won where-after a sixteenth operation 88 sets up fund transfer to provide the promised loan.

Control then passes to the exit 84 to end the auction process.

The sixteenth operation 88 preferably sets up fund transfer by accepting funds from the lender client 16 into an escrow account held on behalf of the auction server 10 which the borrower client 14 can then access. The sixteenth operation 88 can also arrange transfer from the escrow account from the borrowing client 14 to the lending client 16 when payments are due. In one possibility, guarantor clients 18 20 can receive payment directly from the lending client, the amount periodically paid by the borrowing client having the cost of the one or more guarantor client 18 20 costs being added to the periodical payments made to the lending client 16. In another possibility, the cost of the guarantor clients 18 20 can be made, either directly or though the escrow account, from the borrowing client 14 to the one or more guarantor clients 18 20. Those skilled in the art will be aware of other payment set-up procedures and methods that fall within the invention as hereafter claimed.

It is to be appreciated that FIG. 5 shows just one of many ways that the auction server 10 can arrange for overall conducting of the auction process, and that those skilled in the art will be aware of variations and modifications that can be used without departing from the scope of the invention as here after claimed.

In the invention as described, the auction server 10 automatically arranges and facilitates all activities within the auction process with the absolute minimum of human intervention and decision.

The invention is further made clear and defined by the following appended claims.

1. A method for auctioning provision of a loan automatically employing an auction server the method comprising:
a step of the auction server automatically providing an auction server website;
a step of the auction server automatically interacting with a borrowing client to post a borrowing request on the auction server website on behalf of the borrowing client;
a step of the auction server automatically interacting with at least one lending client to receive a bid to win a first auction to provide the requested loan amount;
a step of the auction server automatically interacting with at least one default guarantor client to receive a bid to win a second auction to provide a default guarantee for the requested loan amount;
a step of the auction server automatically terminating the auction process when one or more predetermined criteria are met; and
a step of the auction server automatically selecting the lowest cost bidder for the first auction and the lowest cost bidder for the second auction for presentation to the borrowing client for acceptance of the loan offer.

2. The method, according to claim 1, wherein the one or more criteria include at least one of: the end of a predetermined period of elapsed time; the overall load cost falling below a preset value selected by the borrowing client; the interest rate set by a lending client falling below a preset value selected by the borrowing client; the interest rate set by a default guarantor client falling below a preset value selected by the borrowing client.

3. The method, according to claim 2, including,
if the borrowing client accepts the loan offer, a step of the auction server automatically providing an escrow account for deposition of the loan amount by the lending client and for making available the loan amount to the borrowing client.

4. The method, according to claim 3, including;
a step of the auction server automatically allowing deposition of monies by the borrowing client when payments are due; and
a step of the auction server automatically allowing transfer of monies to at least one of:
the lending client; and the default guarantor client.

5. The method of claim 1 including;
a step of the auction server automatically interacting with at least one exchange rate guarantor client to receive a bid to win a third auction to provide an exchange rate guarantee for the requested loan;
where
the step of the auction server automatically selecting the lowest cost bidder for the first auction and the lowest cost bidder for the second auction for presentation to the borrowing client for acceptance includes the additional step of automatically selecting the lowest cost bidder for the third auction for presentation to the borrowing client for acceptance.

6. The method, according to claim 3, wherein the one or more criteria include at least one of: the end of a predetermined period of elapsed time; the overall load cost falling below a preset value selected by the borrowing client; the interest rate set by a lending client falling below a preset value selected by the borrowing client; the interest rate set by a default guarantor client falling below a preset value selected by the borrowing client; and the interest rate set by an exchange rate guarantor client falling below a preset value selected by the borrowing client.

7. The method, according to claim 6, including,
if the borrowing client accepts the loan offer, a step of the auction server providing an escrow account for deposition of the loan amount by the lending client and for making available the loan amount to the borrowing client.

8. The method, according to claim 7, including;
a step of the auction server allowing deposition of monies by the borrowing client when payments are due; and
a step of the auction server allowing transfer of monies to at least one of: the lending client; the default guarantor client; and the exchange rate guarantor client.

9. A system for auctioning provision of a loan; the system comprising:
an auction server;
the auction server comprising website provision means operable to provide an auction server website;
the auction server comprising borrowing client interaction means operable to interact with a borrowing client and to post a borrowing request on the auction server website on behalf of the borrowing client;
the auction server comprising lending client interaction means operable to interact with at least one lending client to receive a bid to win a first auction to provide the requested loan amount;
the auction server comprising default guarantor interaction means operable to interact with at least one default guarantor client to receive a bid to win a second auction to provide a default guarantee for the requested loan amount;
the auction server comprising termination means, operable to terminate the auction process when one or more predetermined criteria are met; and
the auction server comprising bidder selection means operable automatically to select the lowest cost bidder for the first auction and the lowest cost bidder for the second auction and further operable to present the selected bids to the borrowing client for acceptance of the loan offer.

10. The system, according to claim 9, wherein the one or more criteria include at least one of: the end of a predetermined period of elapsed time; the overall load cost falling below a preset value selected by the borrowing client; the interest rate set by a lending client falling below a preset value selected by the borrowing client; the interest rate set by a default guarantor client falling below a preset value selected by the borrowing client.

11. The system, according to claim 10, wherein;
the auction server comprises financial means, operable if the borrowing client accepts the loan offer, automatically to providing an escrow account for deposition of the loan amount by the lending client and for making available the loan amount to the borrowing client.

12. The system, according to claim 11, wherein:
the auction server comprises repayment deposition means, operable to allow deposition of monies by the borrowing client when payments are due and to allow transfer of monies to at least one of: the lending client; and the default guarantor client.

13. The system of claim 9 wherein;
the auction server comprises exchange rate guarantor interaction means operable to interact with at least one exchange rate guarantor client to receive a bid to win a third auction to provide an exchange rate guarantee for the requested loan;
where
the bidder selection means also comprises means operable automatically to select the lowest cost bidder for the third auction and operable to present the bid to the borrowing client for acceptance.

14. The system, according to claim 13, wherein the one or more criteria include at least one of: the end of a predetermined period of elapsed time; the overall load cost falling below a preset value selected by the borrowing client; the interest rate set by a lending client falling below a preset value selected by the borrowing client; the interest rate set by a default guarantor client falling below a preset value selected by the borrowing client; and the interest rate set by an exchange rate guarantor client falling below a preset value selected by the borrowing client.

15. The system, according to claim 14 wherein,
the auction server comprises financial means, operable if the borrowing client accepts the loan offer, automatically to providing an escrow account for deposition of the loan amount by the lending client and for making available the loan amount to the borrowing client.

16. The system, according to claim 15, wherein;
the auction server comprises repayment deposition means, operable to allow deposition of monies by the borrowing client when payments are due and to allow transfer of monies to at least one of: the lending client; and the default guarantor client.
